(19) United States
(12) Patent Application Publication
(10) Pub. No.: US 2006/0104224 A1
(43) Pub. Date: May 18, 2006

(54) Wireless access point with fingerprint authentication

(76) Inventors: Gurminder Singh, Cupertino, CA (US); Baldev Krishan, Fremont, CA (US)

Correspondence Address: G. VICTOR TREYZ, FLOOD BUILDING, 870 MARKET STREET, SUITE 984, SAN FRANCISCO, CA, 94102, US

(21) Appl. No.: 10/965,422

(22) Filed: Oct. 13, 2004

(51) Int. Cl. H04B 7/00

(52) U.S. Cl. 370/310

(57) ABSTRACT

A wireless local area network access point is provided that authenticates users using fingerprint recognition. Users may register fingerprints with the wireless access point with the assistance of an authorized system administrator. When a registered user attempts to access the network, the user may be prompted to provide a fingerprint scan. A fingerprint reader in the user's equipment may be used to capture the user's fingerprint. The captured fingerprint may be submitted to the wireless access point for comparison with a database of fingerprints of authorized users. If the captured fingerprint is valid, the user may be granted wireless network access by the access point.

### BACKGROUND OF THE INVENTION

This invention relates to wireless networking, and more particularly, to wireless access points with fingerprint authentication capabilities.

Local area networks are used to interconnect computers in home and office environments. With a typical arrangement, multiple computers are interconnected using Ethernet networking.

Although Ethernet networks are popular, wired Ethernet local area networks (LANs) require extensive cabling. Accordingly, wireless local area networks are becoming increasingly popular.

With wireless LAN (WLAN) technology such as IEEE 802.11a/b/g wireless LAN arrangements, a user with a notebook computer that has appropriate wireless network capabilities can log on to the network without making any physical wired connections. Wirelessly connected users are free to roam within range of the wireless access point for the LAN.

Although wireless LANs are convenient, they raise security challenges because they are relatively exposed to potential attackers. Conventional techniques for controlling access to wireless LANs are based on SSID (Service Set Identifier) passwords, WEP (Wired Equivalent Privacy) encryption, and MAC (Media Access Control) address filtering.

The Service Set Identifier (SSID) of a wireless LAN is an identification value programmed into the LAN's wireless access point. If a user's computer cannot provide the correct SSID to a network, access to the network is denied by the access point. The SSID acts as a shared password between the access point and its associated users. The security provided by SSIDs is weak, because SSIDs are not encrypted during transmission and can be intercepted by unauthorized users.

Wired equivalent privacy encryption techniques are intended to protect networks against eavesdropping. WEP encryption standards are specified by the IEEE 802.11 architecture. With WEP techniques, the packets that are transmitted wirelessly over a wireless network are encrypted. However, WEP encryption schemes can be broken by intercepting and analyzing a large number of encrypted packets.

MAC address filtering allows a LAN access point to permit or deny network access to clients based on known MAC addresses. MAC addresses have long been used as the singularly unique layer 2 network identifier in LANs. Through controlled, organizationally unique identifiers (OUI) allocated to hardware manufacturers, MAC addresses are globally unique for all LAN-based devices in use today. In many cases, the MAC address of a workstation is used as an authentication factor or as a unique identifier for granting varying levels of network or system privilege to a user.

User tracking and authentication operations based on MAC address filtering can be employed in wireless LANs such as 802.11 WLANs. However, authentication schemes based on MAC addresses can be cumbersome to implement, particularly when there are a large number of users in the system. Moreover, attackers can often penetrate a network secured using MAC address filtering by intercepting and reusing a legitimate MAC address. MAC address filtering also validates the identity of the equipment but not the user.

It would therefore be desirable to be able to provide improved security for wireless local area networks.

### SUMMARY OF THE INVENTION

In accordance with the present invention, a wireless local area network (wireless LAN) is supported using a wireless access point. System operations may be administered by an administrator. The administrator may, for example, be involved in the process of registering users and adjusting registration settings.

Fingerprint authentication may be used to authenticate users of the wireless LAN. When a new user is registered, the user's fingerprints are captured. The captured fingerprints may then be stored in the access point by the administrator. A userID may be stored with registered fingerprints to facilitate authentication operations.

When a user desires to wirelessly access the LAN, the user is prompted to supply a fingerprint for authentication. After the user's fingerprint has been captured at the user's computer, the captured fingerprint may be submitted to the wireless access point for authentication.

During authentication operations, the wireless access point may compare the user's fingerprint to the fingerprint that was stored when the user registered with the system. If the newly captured fingerprint matches the fingerprint that was supplied during registration, the access point can conclude that the user's fingerprint is valid and can provide the user with wireless access to the resources of the local area network. If the new fingerprint does not match the fingerprint stored at the wireless access point, the wireless access point can provide the user with an error message and can deny network access.

An administrator can specify how many fingerprints are required to access the system. If, for example, three fingerprints are required, a user who supplies only two valid fingerprints will be denied network access.

Fingerprint-based access control can be used to supplement other security mechanisms such as MAC address filtering, SSID schemes, and other access control arrangements.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative system and local area network in which a wireless access point with fingerprint authentication capabilities may be used in accordance with the present invention.

FIG. 2 is a diagram of an illustrative wireless access point in accordance with the present invention.

FIG. 3A is a diagram of a wireless access point with a network interface card with an integrated fingerprint reader in accordance with the present invention.

FIG. 3B is a diagram of a wireless access point with an external fingerprint reader in accordance with the present invention.

FIG. 4 is a flow chart of illustrative steps involved in using the system of FIG. 1 to provide fingerprint authentication and wireless network access in accordance with the present invention.

FIG. 5 shows an illustrative administrator login screen that may be displayed for a system administrator in accordance with the present invention.

FIG. 6 is an illustrative administrator login confirmation screen that may be displayed for an administrator in accordance with the present invention.

FIG. 7 is a flow chart of illustrative steps involved when an administrator is logging into the system and adjusting settings in accordance with the present invention.

FIG. 8 is an illustrative new user registration screen that may be displayed for a user during new user registration operations in accordance with the present invention.

FIG. 9 is an illustrative screen that may be displayed to provide a user with instructions on fingerprint scanning during fingerprint registration operations in accordance with the present invention.

FIG. 10 is an illustrative screen that may be displayed for a user to provide the user with information on the fingerprint scanning process during user registration operations in accordance with the present invention.

FIG. 11 is an illustrative confirmation screen that may be displayed for a user at the end of the user registration process in accordance with the present invention.

FIG. 12 is a flow chart of illustrative steps involved during new user registration operations in accordance with the present invention.

FIG. 13 is an illustrative user login screen that may be presented to a user to allow the user to log in to the network using fingerprint authentication in accordance with the present invention.

FIG. 14 is a flow chart of illustrative steps involved in authenticating a user using fingerprint recognition and granting a valid user wireless network access in accordance with the present invention.

### DETAILED DESCRIPTION OF THE PREFERRED EMBODIMENTS

The present invention relates to wireless local area networks, wireless access points for local area networks, and methods for restricting access to wireless local area networks using fingerprint authentication.

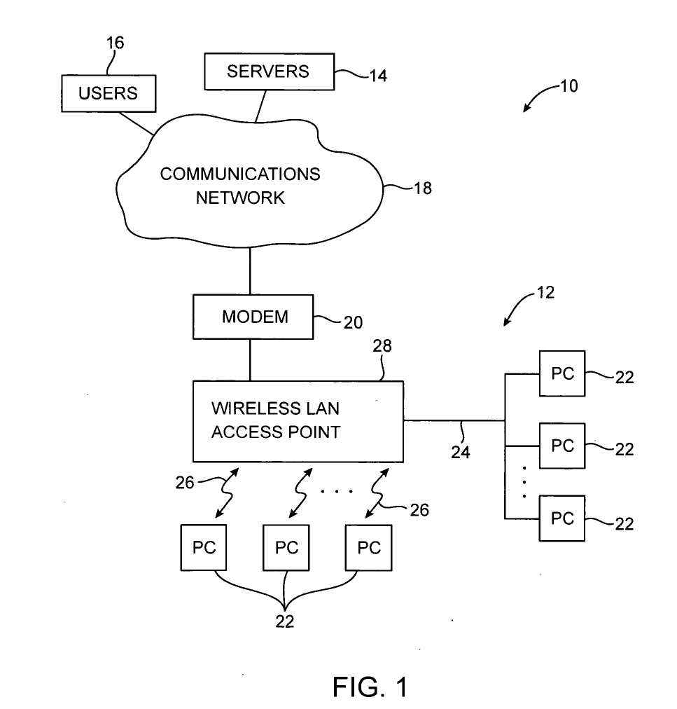

A system environment in which a wireless local area network in accordance with the present invention may operate is shown in FIG. 1. In system 10, wireless local area network 12 is connected to resources such as servers 14 and users 16 through communications network 18. Communications network 16 may be, for example, the Internet. A modem 20 in local area network 12 may be used to connect local area network 12 to communications network 16. The modem 20 may be, for example, a cable modem or a DSL modem. The modem 20 allows users in network 12 to send and receive email messages with users such as users 16, to obtain web content from servers 14, etc.

Network 12 contains multiple computers 22. Computers 22 may be personal computers, notebook computers, workstations, handheld computers, or any other suitable computing devices. Wireless LAN access point 28 may be used to connect computers 22 to the network 12. Computers 22 may be connected to LAN 12 wirelessly using wireless connections 26. Wireless access point 28 may, if desired, have one or more Ethernet ports or other wired ports to accept wired connections. In the example of FIG. 1, some of personal computers 22 are connected to access point 28 using wired connections 24. Wired connections 24 may be based on Ethernet cables or other suitable network wiring.

In general, any suitable resources may be connected to network 12. For example, printers, storage devices, communications devices, and other resources may be connected to network 12. Access policies may be used to regulate which users in network 12 can use particular resources. For example, access policies may be used to restrict access to a particular printer to certain specified users. Access policies may also be used to restrict which users have access to particular storage device or have Internet access.

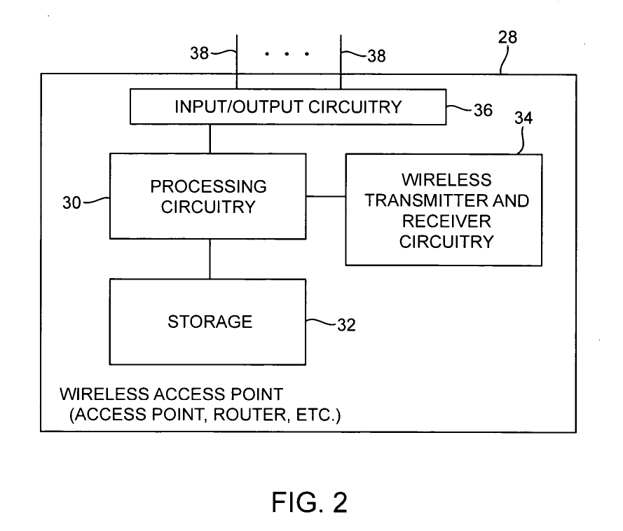

An illustrative access point 28 is shown in FIG. 2. Processing capabilities may be provided using processing circuitry 30. Any suitable processor or processors may be used to provide processing capabilities for access point 28. For example, access point 28 may have a microprocessor, microcontroller, digital signal processor, application specific integrated circuit, custom logic, other suitable processing circuits, and combinations of such circuits for providing the processing capabilities of processing circuitry 30. Processing functions may be provided using a combination of hardware and software. Access point 28 may be configured to perform its desired functions by loading and running the appropriate access point software on the processing circuitry 30 and other hardware of access point 28.

Storage 32 may be used to store software and data. For example, storage 32 may be used to store authentication information such as fingerprint templates for authenticating users. Storage 32 may also be used to store operating instructions (software) for controlling the operation of access point 28. Any suitable memory and storage devices may be used in storage 32. For example, random-access-memory may be used to support one or more memory caches and may be used for holding instructions executed by processing circuitry 30. A hard disk drive may be used if more extensive storage is desired. Non-volatile memory may be used for boot ROM and other non-volatile storage needs. Some of storage 32 may be provided by memory that is located on the same chip as a processing circuit in processing circuitry 30 (e.g., a memory block on a microprocessor). These are merely illustrative arrangements for storage 32. Any suitable storage technology may be used for access point 28 if desired.

Access point 28 has wireless transmitter and wireless receiver circuitry 34 to allow computers 22 and other wireless-capable resources to wirelessly connect to the local area network 12. Wireless access point 28 may support wireless connections using any desired protocols. As an example, wireless access point 28 may use a combination of the IEEE 802.11 standards such as 802.11(b), 802.11(a), and 802.11(g). Access point 28 may, for example, be a 802.11 b/g access point, an 802.11 a/b/g access point, an 802.16 access point etc. Other standards may be supported if desired.

Input/output circuitry 36 may be used to connect access point 28 to other resources in network 12 using wired connections. For example, a USB port in input/output circuitry 36 or an Ethernet port in input/output circuitry 36 may be used to connect access point 28 to modem 20 or other external communications devices via input/output connections 38. If desired, the modem 20 may be incorporated into access point 28. As an example, access point 28 may have an integral cable modem to eliminate the tasks associated with setting up an external modem during network setup operations.

The input/output circuitry 36 may include Ethernet ports and switches or other suitable input/output circuits to allow access port 28 to connect to computers 22, storage devices such as external drives, printers, scanners, and other network resources. Wired connections 24 such as Ethernet cables may be used to connect resources to access point 28 via input/output circuitry 36. Input/output circuitry may include Ethernet ports, parallel ports, serial ports (e.g., USB ports), and other input/output ports to which peripherals may be connected directly and may include ports (e.g., USB or Ethernet ports) to which a group of peripherals may be connected through a hub or other distributed network arrangement.

The processing circuitry 30, storage 32, wireless transmitter and receiver circuitry 34, and input/output circuitry 36 may be used to support any desired wireless access port functions. For example, access point 28 may use these resources to support wired networking, print serving functions, firewall functions, security functions, etc. These capabilities may be provided in any suitable combination, depending on the needs of network 12.

Access point 28 may support data encryption. For example, data transmitted over wireless connections 26 by wireless transmitter and receiver circuitry 34 may be encrypted using wired equivalent privacy (WEP) cryptographic techniques. Additional security may be provided by using MAC address filtering to restrict access to network 12 to certain known computers 22.

Using an internal print server function, users in LAN 12 can print to the printer(s) attached to access point 28 via input/output circuitry 36.

Access point 28 may have switches in input/output circuitry 36 that serve as a wired hub for interconnecting computers 22 with wired connections. For example, access point 28 may include a four-port full-duplex 10/100 Ethernet switch to connect computers 22 and other wired Ethernet devices to LAN 12.

Access point 28 may include router capabilities. For example, router functionality may be provided that allows computers 22 that are connected to access port 28 to share a cable or DSL Internet connection through modem 20 and to share devices such as printers and hard disks connected to access point 28.

Access point 28 may include a firewall and may support virtual private networking functions.

Depending on the features incorporated into access point 28, access point 28 may be referred to as a wireless access point, a wireless router, a wireless access point router, a wireless gateway, etc. These different types of access point are referred to collectively herein as an “access point” or a “wireless access point.”

To ensure that access point 28 is not too costly, access point 28 preferably does not have general-purpose computer features such as a keyboard or display.

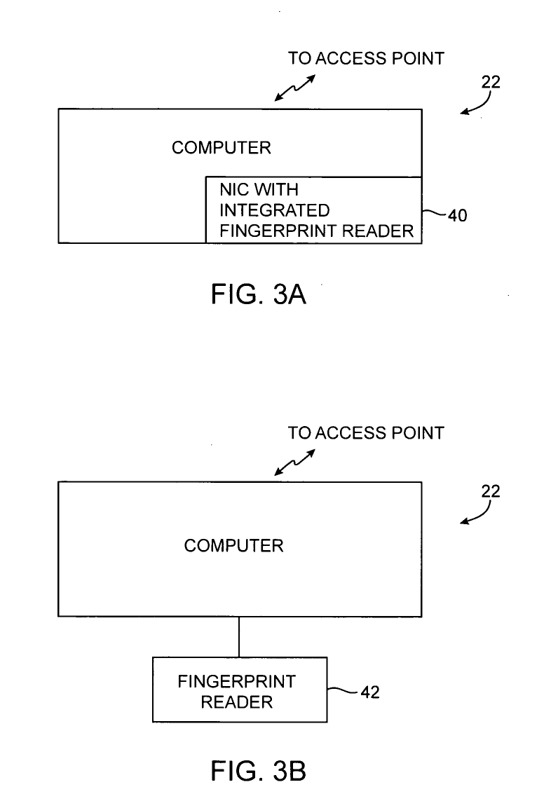

Any suitable computers 22 may be used in local area network 12 such as personal computers, notebook computers, workstations, handheld computers, etc. To support fingerprint authentication functions, computers 22 preferably have fingerprint reading capabilities. A fingerprint reader (sometimes referred to as a fingerprint scanner) may be included with each computer 22. FIG. 3A shows how a computer 22 may have a network interface card (NIC) with an integrated fingerprint reader 40. FIG. 3B shows how a computer 22 may have an external fingerprint reader 42. An external fingerprint reader 42 may be connected to computer 22 using a USB cable or any other suitable communications path. The external fingerprint reader 42 may, for example, be connected to the main unit in computer 22 using a USB connection, an RS-232 connection, or other suitable serial or parallel wired connection.

The fingerprint reader for each computer 22 may be used to acquire a fingerprint scan for the user using that computer. The access point 28 can use the fingerprint of the user to determine whether the user is a valid member of local area network 12 or is an attacker. If the user has a valid fingerprint, the user can be logged into the network 12 and granted access to network resources.

The fingerprint data acquired by the fingerprint readers may be stored using any suitable format. For example, data storage and transmission requirements may be reduced by using a data compression format suitable for fingerprint data (e.g., by noting unique minutia points such as ridge endings and bifurcations in a fingerprint and/or the positions of various fingerprint swirls and other characteristics, etc.). The fingerprint data acquired by the fingerprint reader 20 is sometimes referred herein to as a “fingerprint scan” or “fingerprint.”

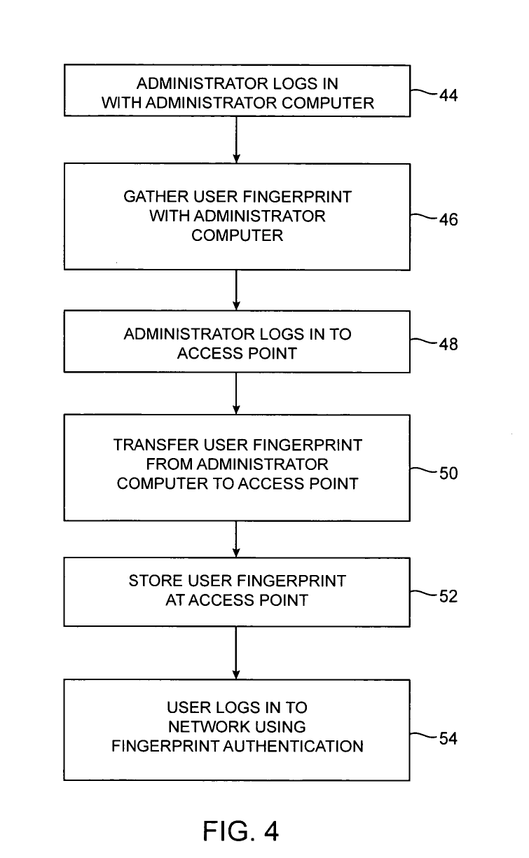

An overview of illustrative steps involved in using access point 28 to restrict access to wireless local area network 12 is provided in FIG. 4. In the illustrative example of FIG. 4, a new user is registered with network 12. The new user can then use fingerprint authentication to access network 12.

At step 44, a network administrator logs into network 12 or logs into the administrator's computer 22. The administrator is a network user who is authorized to register new users. Administrators typically have other responsibilities, such as adjusting network security settings, etc. The administrator is typically associated with one of the computers 22 of network 12. In a home network, the administrator is typically an active user of the network 12. During logon procedure 44, the administrator's computer or other computer equipment in network 12 may be used to check the administrator's credentials. Once the administrator's identity and authorization has been verified, the administrator may be logged in.

During the administrator login procedure, the administrator may be authenticated using a suitable authentication technique, such as username and password authentication, fingerprint authentication, etc. The administrators' computer 22 and other suitable equipment in network 12 may be used to verify the administrator's credentials during step 44.

After the administrator has logged in, the administrator can supervise the gathering of the fingerprint scan of the new user. In a typical scenario, the administrator logs in to the administrators' computer 22. The administrators' computer 22 has a fingerprint reader for taking fingerprint scans. During step 46, the administrators asks a new user to place their finger(s) on the fingerprint reader associated with the administrator's computer. The administrator or user may then interact with clickable on-screen options displayed on the administrator's computer that guide the administrator and user through the new user fingerprint registration process. The access point setting that specifies the number of fingers that must be scanned for registration and authentication may be adjusted by the administrator using interactive screens.

The administrator can supervise the new user during the registration process to make sure that the new user complies with proper fingerprint scanning procedures and does not submit a fraudulent fingerprint. This helps ensure that the new user's fingerprint is accurately obtained and that the security of network 12 is not compromised.

After the fingerprint of the new user has been captured at step 46, the new fingerprint can be provided to the wireless access point 28. To ensure that the fingerprint is securely transferred to the access point 28, the administrator can log into the access point at step 48. Any suitable technique may be used to log into the access point 28. With a typical arrangement, the administrator uses a web browser on the administrator computer 22 to retrieve a web page from access point 28. Access point 28 serves as a web server in this capacity and provides the web page to the administrator computer 22. A secure protocol (e.g., secure sockets layer—SSL) may be used to ensure that the access point 28 delivers the web page to the administrator computer 22 securely.

The web page that is provided to the administrator contains a number of selectable options (e.g., options related to the settings for access point 28 such as WEP settings, MAC settings, SSID settings, fingerprint settings, etc.) The web page provided to the administrator computer also preferably contains options that the administrator can select to upload the fingerprint of the new user. The administrator can select an “upload” option or other suitable option on this web page to initiate the transfer of the fingerprint of the new user from the administrators' computer to the access point 28 at step 50. If desired, the functionality associated with adjusting access point settings and transferring fingerprint scans from administrator computers to the access point may be provided using other suitable formats. The use of a web-page-based format is merely illustrative.

After the access point 28 receives the fingerprint data for the new user, the access point 28 stores the fingerprint(s) in storage 32 at step 52. The fingerprint scans that are stored in storage 32 may be stored using any suitable format. For example, the fingerprint scans may be stored in a database of authorized network users with corresponding userID information.

After the fingerprint registration process is complete, the access point 28 has information on the fingerprints of authorized users of network 12. The new user can therefore use a computer 22 with a fingerprint scanner to log into the network 12. During the login procedure, the access point 28 requires that the new user provide a fingerprint scan for authentication. The fingerprint reader in the user's computer 22 can be used to capture the user's fingerprint. By comparing the newly captured fingerprint of the user to the fingerprint that is stored in storage 32, the access point 28 can determine whether the new user is authorized to access the resources of network 12. If the fingerprint matches, the access point 28 can grant the new user network access. If the fingerprint does not match, access can be denied.

In the example of FIG. 4, the administrator logs into the administrator computer before supervising the registration of a new user. The administrator then logs into the access point before the captured fingerprints of the new user are transferred to the access point for registration. If desired, the administrator need only log in to the access point 28. With this type of approach, the access point 28 checks the administrator's credentials. If the administrator's credentials are authentic, the new user registration process may be implemented by using the access point to provide appropriate registration screens to the administrator's computer. After the user's fingerprints are captured, the captured fingerprints are stored at the access point. While this approach may be satisfactory, in a more typical approach the network administrator will log in to the administrator's computer 22 before capturing the user's fingerprint.

The format and quantity of interactive screens that are displayed for users during registration and authentication procedures depends on the type of user experience that is desired. In general, the use of more screens provides more on-screen real estate in which to display user-selectable options and explanatory text and graphics. The user of fewer screens may be more efficient. In general, any suitable number and type of screens may be displayed.

Some screens may be generated and displayed with software running on the computers 22. For example, a web browser running on a computer 22 may be used to display web content provided by a web server implemented on access point 28. As another example, software running on an administrator's computer 22 may be used to authenticate the administrator when the administrator logs in to that computer. Software on user computers 22 and/or access point 28 may display logon screens when registered users are logging into network 12 through access point 28. In general, any suitable number and types of screens may be displayed and any suitable equipment may be used to present these screens in system 10. The screens described herein are merely illustrative.

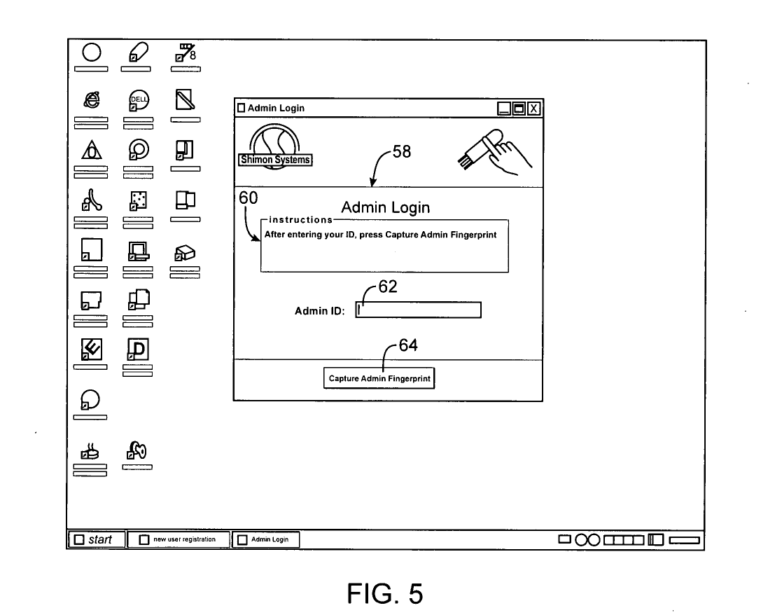

An illustrative administrator login screen 56 is shown in FIG. 5. Screen 56 may contain a title 58 that informs the user that screen 56 is an administrator login screen. Instructions 60 may instruct the administrator how to log in. Any suitable authentication technique may be used for administrator login operations. In the example of FIG. 5, instructions 60 direct the administrator to enter an administrator user ID (“adminID”) in adminID box 62 and to click on the capture admin fingerprint 64. The administrator's computer 22 has a fingerprint reader on which the administrator places an appropriate finger before clicking on option 64.

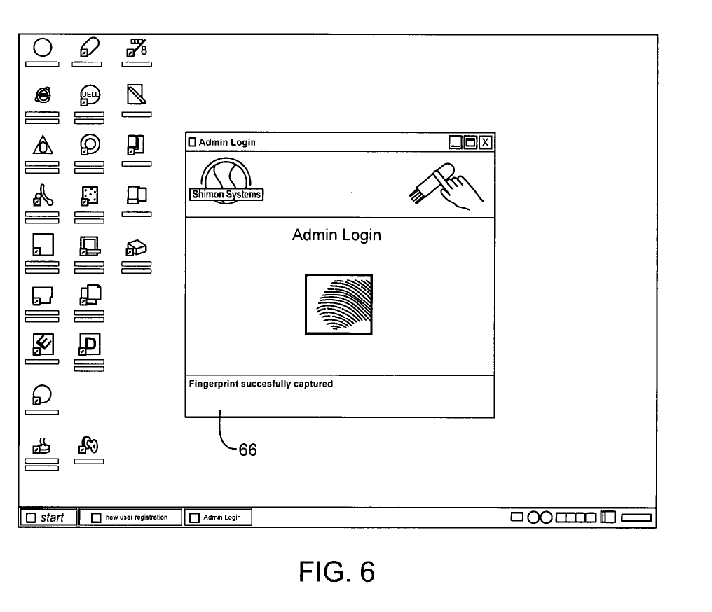

After the administrator clicks on option 64, the administrator's fingerprint is captured using the fingerprint reader. The captured fingerprint is compared to a stored version of the administrator's fingerprint. If the captured fingerprint data matches the stored fingerprint data, the administrator may be authenticated and allowed to log in. As shown in FIG. 6, a confirmation screen 66 may be displayed to confirm to the administrator that the fingerprint has been successfully processed.

Screens such as screen 56 (FIG. 5) and screen 66 (FIG. 6) may be presented to the administrator when the administrator logs on to the administrator's computer 22 and/or when the administrator logs on to the access point 28. If the login techniques required for administrator login to computer 22 and access point 28 are different, different sets of screens may be presented to the administrator. For example, the administrator may log in to the administrator's computer 22 using username and password authentication and may log in to access point 28 using fingerprint authentication. For purposes of illustration, the screens shown in FIG. 5 and 6 use fingerprint authentication techniques.

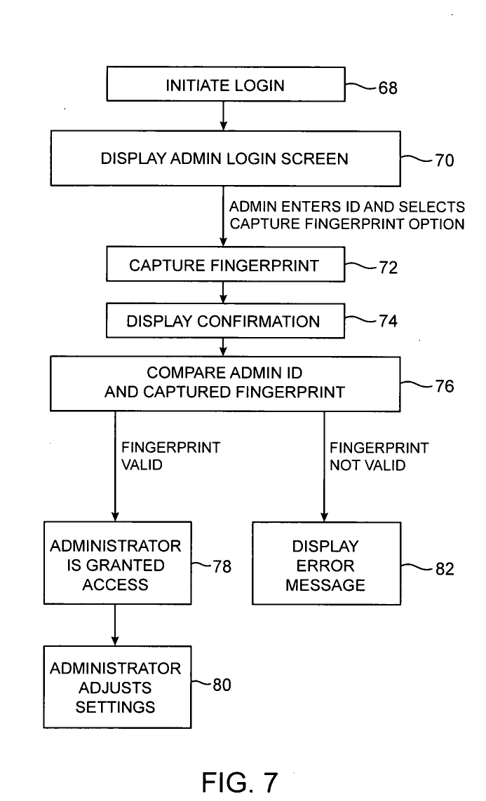

Illustrative steps involved in administrator login procedures are shown in FIG. 7.

At step 68, the administrator initiates the login process. During login procedures with the administrator's own personal computer, the administrator may, for example, click on a login icon or a login program may be launched automatically during the boot-up process. During login procedures with access point 28, the administrator may launch a web browser and type in an appropriate URL.

At step 70, an administrator login screen such as login screen 56 of FIG. 5 may be displayed for the administrator. After reading the instructions on screen 56, the administrator may type in the requested adminID in box 62 and click on option 64.

In response, the computer 22 may be directed to use its fingerprint reader to take a scan of the administrator's fingerprint. After the administrator's fingerprint has been captured at step 72, a confirmation screen such as confirmation screen 66 of FIG. 6 may be displayed at step 74.

At step 76, the administrator ID may be used to look up the administrator's previously registered fingerprint. The registered fingerprint data that is retrieved may then be compared to the fingerprint captured and submitted at step 72. If the registered fingerprint and captured fingerprints match, the captured fingerprint is valid. If the captured fingerprint does not match the registered fingerprint for the administrator, the fingerprint is not valid. If desired, the entire database of registered fingerprints may be searched for a match, in which case the administrator need not be asked to present an administrator ID during logon. Submission of a valid fingerprint will suffice.

If the administrator's fingerprint is valid, the administrator may be granted access to appropriate resources on computer 22 and/or access point 28 at step 78.

The administrator may then perform tasks such as registering new users and adjusting access point settings (step 80). For example, the administrator may use a web page interface or other suitable interface to adjust a setting that determines how many fingers must be registered during user registration (one finger, two fingers, three fingers, etc.).

If the administrator's fingerprint is not valid, an error message may be displayed for the administrator at step 82.

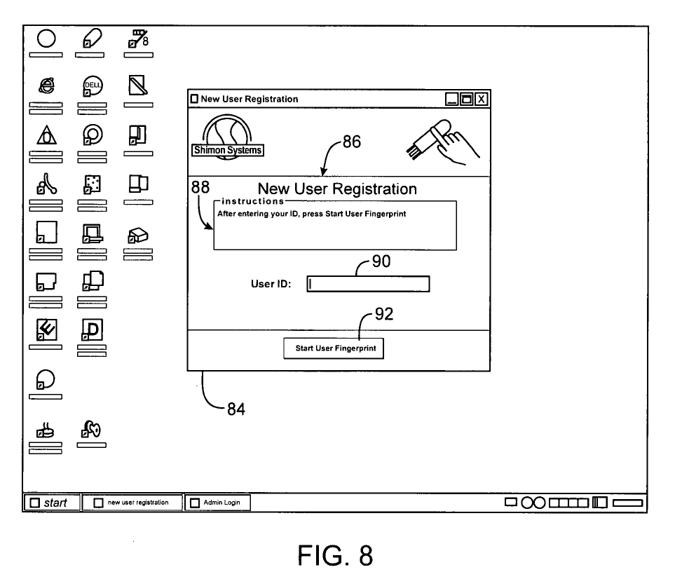

Illustrative screens that may be displayed for a new user during the process of registering a fingerprint with access point 28 are shown in FIGS. 8-11. The format and content of these screens is merely illustrative. Any suitable number of screens with any suitable format and content may be presented to the user if desired.

As shown in FIG. 8, a new user who desires to register one or more fingerprints may be presented with a screen such as screen 84 of FIG. 8. Screen 84 may be displayed by the administrator's computer 22 or other suitable computer 22 or equipment in system 10.

Screen 84 may include title information 86 that informs the new user of the screen's function. Instructions 88 may direct the user to enter a new or existing UserID in box 90. The instructions 88 may also direct the user to select start user fingerprint option 92 when the user is ready to have a fingerprint scan captured.

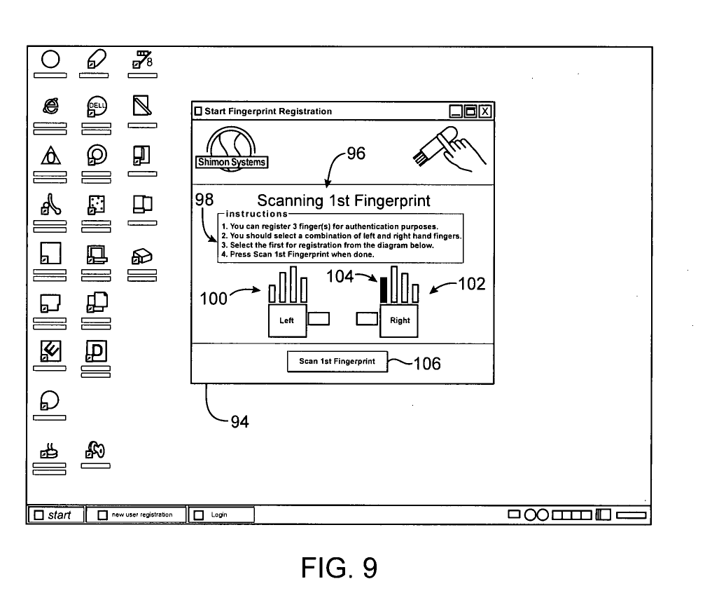

When the user clicks on option 92, the user may be presented with a screen such as screen 94 of FIG. 9. As shown in FIG. 9, screen 94 may contain title information 96 that informs the user of the function associated with screen 94. Instructions 98 may include information that directs the user how to capture one or more fingerprint scans. In the example of FIG. 9, the instructions 98 inform the user that the user can register up to three fingers for use in subsequent authentication operations with access point 28. Instructions 98 may suggest to the user that the user include both right-hand and left-hand fingers for registration. If the user sustains an injury that makes it difficult to present a finger that is on one hand, the other hand's fingers can be used.

Screen 94 may include a graphical depiction of the user's left hand 100 and right hand 102. The graphical depiction of the user's hands may be interactive. The user may, for example, click on the graphically-displayed fingers in hands 100 and 102 to select those fingers for use in the registration process. In the example of FIG. 9, the user has clicked on the right index finger 104 and this finger has been highlighted to confirm to the user that it has been selected. The user may select scan first fingerprint option 106, when the user is ready to proceed.

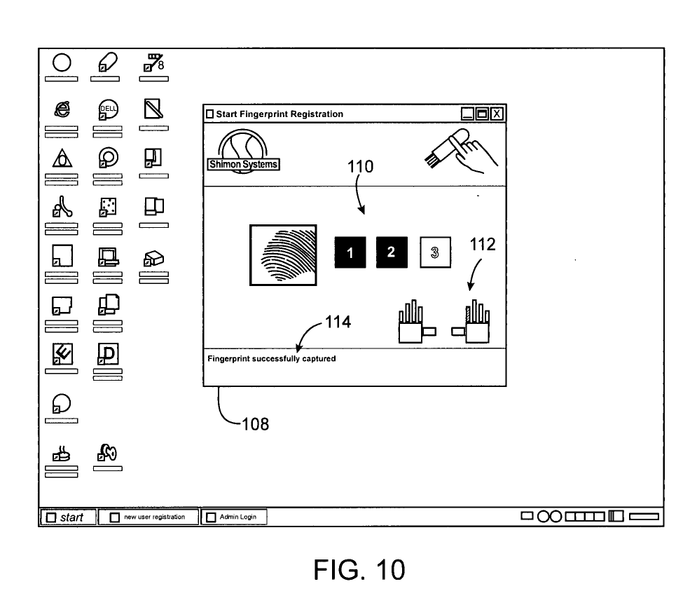

When the user selects option 106, the fingerprint reader captures the user's fingerprint. A screen such as screen 108 of FIG. 10 may be displayed during the fingerprint scanning process. To capture a high-quality fingerprint, it may be desirable to collect data from several redundant scans. This data may be averaged, the sub-optimal scans can be discarded, or other suitable processing techniques may be used to ensure a high-quality capture. When multiple scans are being collected, a graphic such as progress information 110 may be displayed for the user to inform the user of progress through the scanning process. Finger location information such as graphic 112 may be displayed to remind the user which finger is being scanned. The visual display of graphic 112 helps to avoid errors that might otherwise arise from scanning the wrong finger.

When the fingerprint scan has been successfully captured, a confirmation message such as message 114 may be displayed for the user.

If multiple fingerprints are to be captured, the user may use screen 94 of FIG. 9 to select each fingerprint and options such as option 106 to start each fingerprint scan.

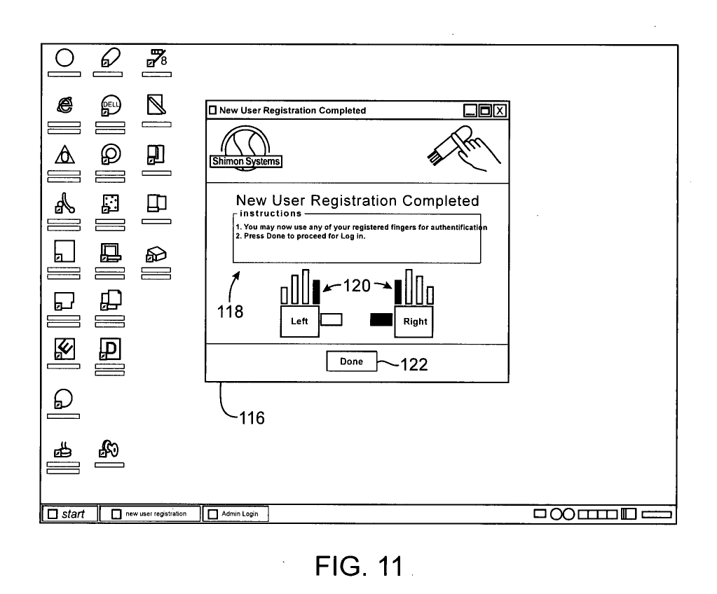

After the appropriate fingerprints have been captured, the user may be presented with a screen such as screen 116 of FIG. 11. As shown in FIG. 11, screen 116 may contain information 118 that informs the user that the fingerprint scans have been successfully captured. The fingers for which fingerprints have been obtained may be darkened in the graphic depictions of the left and right hands 120. Information 118 may contain instructions that direct the user to select done option 122 to complete the fingerprint registrations process.

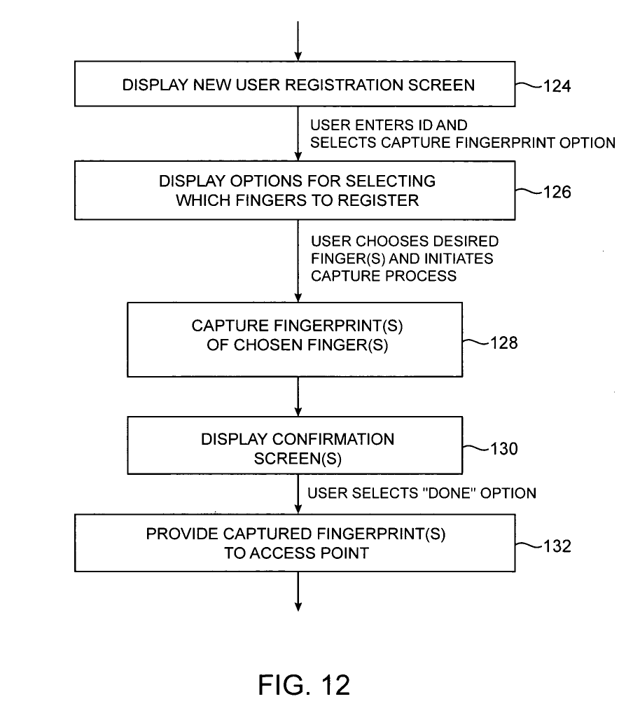

Illustrative steps involved in registering a user's fingerprints are shown in FIG. 12. At step 124, a new user registration screen such as new user registration screen 84 of FIG. 8 may be displayed for the user. The user may enter the user's UserID in box 90 and select start option 92.

In response, options may be displayed that allow the user to select which fingers are to be used during the registration process (step 126). For example, the user may be presented with a screen such as screen 94 of FIG. 9, in which the user can click on certain fingers. When the user clicks on a particular finger, that finger is designated for use during the fingerprint registration process.

At step 128, after the user has selected which finger(s) to register and has clicked on an option such as option 106 to initiate fingerprint capture, the selected fingerprint(s) may be scanned using the fingerprint reader.

Confirmation screens such as screen 108 of FIG. 10 and screen 116 of FIG. 11 may be displayed to inform the user of the progress and completion of the fingerprint scanning process (step 130).

After the process of capturing the fingerprint(s) has been completed, the captured fingerprint information is transmitted to the access point 28 at step 132. The fingerprint information is preferably transferred securely to prevent interception of the fingerprints by attackers. The access point 28 stores the fingerprint information that is received in storage 32. When a user subsequently attempts to log in to access point 28 to connect to network 12 wirelessly, the fingerprints in storage 32 may be used to authenticate the user.

After a new user has registered one or more fingerprints with access point 28, the user can use fingerprint authentication techniques to prove that the user is authorized to wirelessly access network 12. To log on to the network 12 through access point 28, the user creates a fresh fingerprint scan at the time of logon operations. The new fingerprint scan is transmitted to the access point 28, which compares the newly-provided fingerprint to the fingerprint template data stored in storage 32. If the previously registered fingerprint in storage 32 matches the newly-provided fingerprint, the access point 28 may permit the user's computer 22 to wirelessly connect to network 12 via a wireless link 26.

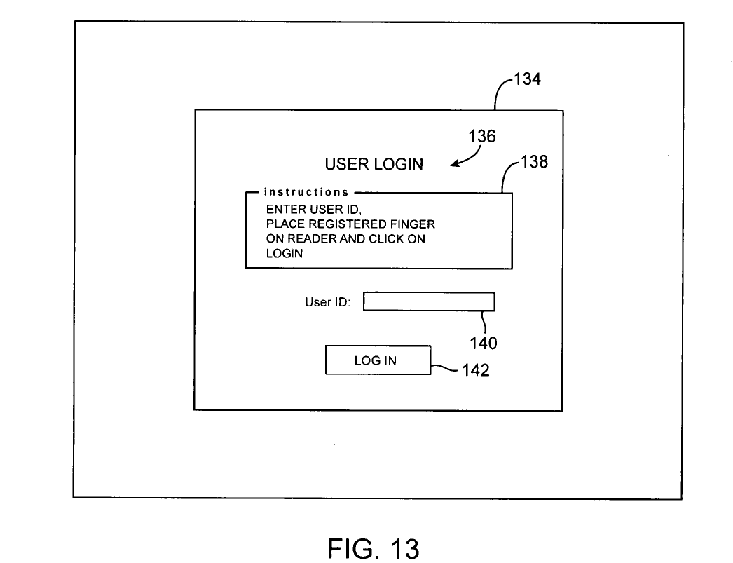

User login operations may be performed using any suitable arrangement. An illustrative user login screen 134 that may be presented to a user by access point 28 when logging in to network 12 is shown in FIG. 13. The illustrative screen 134 includes title information 136 that informs the user of the function of screen 134. Instructions 138 direct the user to enter the user's UserID in box 140 and to select the login option 142. When the user clicks on option 142, the user's fingerprint is captured using the fingerprint reader on the user's computer 22 and the userID from box 140 and the new fingerprint are transmitted securely to access point 28 for authentication. If the fingerprint is valid, access point 28 uses wireless transmitter and receiver circuitry 34 to connect the user's computer 22 to network 12. If the fingerprint is not valid, the access point 28 denies the user access to network 12.

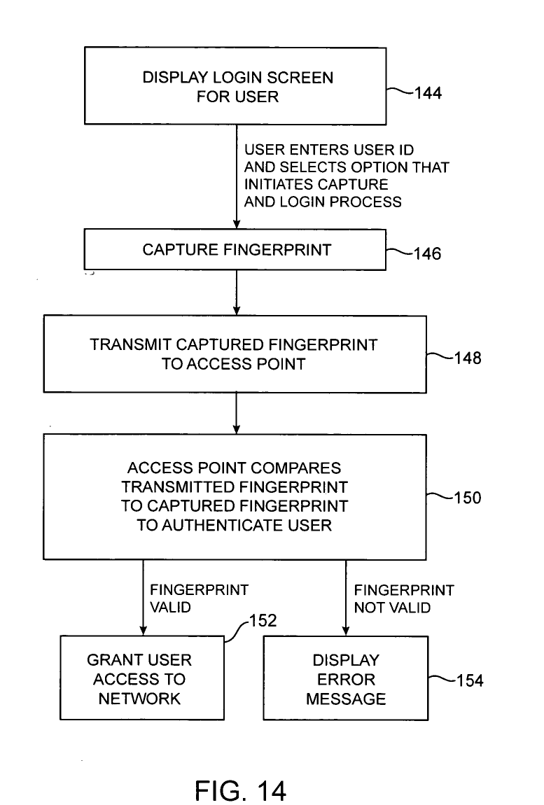

Illustrative steps involved in user login operations are shown in FIG. 14. During the login process, the user's computer interacts with access point 28 over a wireless link 26.

At step 144, the access point 28 may provide a login screen that is displayed on the user's computer 22. One or more login screens of any suitable configuration may be used. These screens may contain information that instructs the user that a fingerprint scan is required. A userID may also be requested. If desired, a userID need not be collected from the user. The access point 28 can compare any submitted fingerprint to the registered fingerprints in storage 32 to determine if there is a match. Requiring the submission of a UserID when logging on helps access point 28 perform authentication operations more efficiently, because the registered fingerprint associated with the UserID can be rapidly retrieved from storage 30. It is not necessary, however, to require a UserID from the user. If desired, icons or non-screen user interfaces may be used to inform the user that a fingerprint is needed and that the logon process has started.

After the user has provided requested information and has placed his finger in the fingerprint reader, the user may click on an option such as login option 142 of FIG. 13 or may otherwise initiate the fingerprint capture operation.

At step 146, the user's fingerprint(s) may be read using the fingerprint reader of the user's computer 22.

At step 148, the captured fingerprint information from the one or more captured fingerprints may be transmitted securely to the access point 28 for verification. The fingerprints may be transmitted using any suitable protocol.

At step 150, the access point 28 may compare the captured fingerprint information that has been submitted by the user to the registered fingerprint data in storage 32. In particular, the access point 28 may use the userID information to locate registered fingerprints (templates) for the user that have been retained in storage 32. The registered fingerprint(s) are then compared to the newly captured fingerprints. If the fingerprints match, the access point 28 can conclude that the submitted fingerprint is valid and that the user is an authentic registered user. The user may then be provided with wireless access to network 12 by supporting a wireless network connection 26 between the user's computer 22 and access point 28. If the newly captured fingerprint does not match a registered fingerprint in storage 32, the access point 28 can conclude that there has been an error in the fingerprint capture process or that the user is not authorized to access the network 12. An error message or other informative message may therefore be displayed for the user at step 154.

Although the invention has been generally described in the context of wireless access points, the fingerprint access-control mechanisms of the invention may also be used with wired local area networks if desired. For example, fingerprint-based access control can be implemented using a wired access point such as a wired router, gateway, firewall, or other suitable LAN network access hardware.

The foregoing is merely illustrative of the principles of this invention and various modifications can be made by those skilled in the art without departing from the scope and spirit of the invention.

What is claimed is:

1. A method for using a wireless access point to restrict access to a wireless local area network having an administrator computer and a plurality of user computers, comprising:
at the administrator computer, capturing a fingerprint of a user;
transmitting the captured fingerprint from the administrator computer to the wireless access point;
registering the user with the wireless access point by storing the captured fingerprint from the administrator computer at the wireless access point;
at a computer of the user, capturing a fingerprint of the user to use in logging on to the local area network;
transmitting the newly-captured fingerprint from the computer of the user to the wireless access point;
at the access point, authenticating the user by comparing the newly-captured fingerprint to the stored fingerprint to determine whether there is a match indicating that the newly-captured fingerprint is valid;
if the wireless access point determines that the newly-captured fingerprint is valid, using the wireless access point to provide the user's computer with wireless network access to the local area network; and
if the wireless access point determines that the newly-captured fingerprint is not valid, using the wireless access point to deny the user's computer wireless network access to the local area network.

2. The method defined in claim 1 wherein registering the user with the wireless access point comprises displaying a new user registration screen for the user on the user's equipment, wherein the new user registration screen contains a region into which the user enters a userID.

3. The method defined in claim 1 wherein using the wireless access point to provide the user's computer with wireless network access to the local area network comprises using an IEEE 802.11 protocol to provide the user's computer with wireless network access to the local area network.

4. The method defined in claim 1 wherein capturing the user fingerprint at the administrator computer comprises displaying selectable options on which fingers to register.

5. The method defined in claim 1 wherein capturing the user fingerprint at the administrator computer comprises using an interactive graphical display of a hand with fingers to select which finger of the user to use to register the user fingerprint.

6. The method defined in claim 1 further comprising displaying at least one confirmation screen for the user at the administrator computer when user registration with the wireless access point is complete.

7. The method defined in claim 1 further comprising using the wireless access point to allow the administrator to select how many fingers are scanned when capturing fingerprints for the wireless access point to authenticate a given user.

8. The method defined in claim 1 further comprising using an external fingerprint scanner that is attached to the user's computer to capture fingerprint scans for the wireless access point.

9. The method defined in claim 1 further comprising using a network interface card with an integral fingerprint scanner in the user's computer to capture fingerprint scans for the wireless access point.

10. The method defined in claim 1 further comprising authenticating the administrator with the wireless access point using fingerprint verification.

11. The method defined in claim 1 wherein before the fingerprint of the user is captured at the administrator computer, the administrator provides the administrator computer with an adminID and an admin fingerprint for authentication.

12. A method for using a wireless access point to restrict access to a wireless local area network having a plurality of computers of users, comprising:
at a computer of a user, capturing a fingerprint of the user;
transmitting the fingerprint from the computer of the user to the wireless access point over a wireless link between the computer and the wireless access point; and
at the access point, authenticating the user using the transmitted fingerprint.

13. The method defined in claim 12 further comprising registering the user with the wireless access point by capturing a fingerprint of the user during a registration process and storing the captured finger in storage at the wireless access point.

14. The method defined in claim 12 wherein authenticating the user further comprises using a userID to authenticate the user at the wireless access point.

15. The method defined in claim 12 wherein authenticating the user comprises:
using a userID to locate a registered user fingerprint stored at the access point and comparing the located registered user fingerprint to the transmitted fingerprint to determine whether there is a match.

16. The method defined in claim 12 further comprising displaying an error message for the user if the wireless access point determines that the transmitted fingerprint is not valid.

17. The method defined in claim 12 further comprising using a port in the wireless access point to connect the local area network to internet access through a modem.

18. The method defined in claim 12 further comprising:
during fingerprint registration, displaying a screen for the user with graphical hands and fingers to click on to select which fingers to register.

19. The method defined in claim 12 further comprising:
making multiple passes of the user's finger to capture the fingerprint of the user with a fingerprint reader.

20. The method defined in claim 19 further comprising:
displaying a screen on an administrator computer that is in communication with the wireless access point; and
in response to administrator interactions with the screen, adjusting how many fingers are to be used when capturing user fingerprint information for authentication with the wireless access point.
